(19) United States
(12) Patent Application Publication
(10) Pub. No.: US 2026/0026652 A1
(43) Pub. Date: Jan. 29, 2026

(54) SEMI-AUTOMATIC DEVICE FOR THE GRINDING OF HERBS AND SIMILAR PRODUCTS

(71) Applicant: Giuseppe Del Giudice, Torchiarolo (IT)

(72) Inventor: Giuseppe Del Giudice, Torchiarolo (IT)

(21) Appl. No.: 19/347,634

(22) Filed: Oct. 1, 2025

Related U.S. Application Data
(63) Continuation-in-part of application No. PCT/IT2024/050068, filed on Apr. 3, 2024.

(30) Foreign Application Priority Data
Apr. 3, 2023 (IT) 102023000006561
Apr. 3, 2024 (WO) PCT/IT2024/050068
Apr. 3, 2024 (WO) PCT/IT2024/050068

(51) Int. Cl. A47J 42/14

(52) U.S. Cl. CPC A47J 42/14

(57) ABSTRACT

This invention concerns a semi-automatic device for grinding herbs and similar products. More specifically, the model concerns an improved manual device that uses an elastic mechanical member to store and release energy, significantly reducing the physical effort required of the user during the grinding operation, while eliminating the need for continuous manual pressure.

### CROSS REFERENCE

This application claims priority to Italian Patent Application No. 102023000006561, filed Apr. 3, 2023, and to International Application No. PCT/IT2024/050068, filed Apr. 3, 2024.

### BACKGROUND ART

The device used for grinding herbs, hereinafter referred to as an herb grinder or herb chopper, is a device consisting of at least two separate parts which, when joined together, form a space called the grinding chamber. The two parts are equipped with mechanical elements suitable for grinding which, by means of their rotary motion, grind the herbs placed inside them into small, uniform pieces ready for use. Currently, in order to use the herb grinder effectively, it is necessary to place the herbs between the empty spaces left by the mechanical grinding elements located in one of the two parts of the grinding chamber and then place the remaining part, also equipped with mechanical grinding elements, on top of it.

Subsequently, the base of the herb grinder is stabilized with one hand and, simultaneously, the other hand is used to rotate the remaining part that forms the grinding chamber with repeated clockwise and anticlockwise movements, while exerting continuous downward pressure to hold the two parts together, allowing the herbs to be ground.

In the event that any resistance is encountered, it is necessary to apply greater force both in the rotary movements and in the pressure required to hold the two parts together. The parts forming the grinding chamber must be rotated until the resistance from the herbs disappears, a clear sign that the herbs have been ground.

Manual devices for grinding herbs currently on the market have several inherent disadvantages. These devices, such as those described in documents like US 2021/235934 A1, EP 0 535 004 B1, DE-A-3 429 044, CN 111 434 295 A, and DE 26 22 143 A1, typically require the user to apply:
(a) a constant rotary force to start and keep the grinding elements in motion; and
(b) a continuous manual pressure force from top to bottom to keep the parts constituting the grinding chamber in close contact.

In particular, the cited documents highlight various applications of elastic members in grinding devices, but none of them efficiently solves the problem of double fatigue for the user:

US 2021/235934 A1 describes pressure springs for adjusting the axial force on coffee beans

EP 0 535 004 B1 and DE-A-3 429 044 use springs for support and vibration reduction purposes

CN 111 434 295 A uses an elastic component to extrude seasonings

DE 26 22 143 A1 describes a spring to push a claw towards a friction disc

Additional documents such as WO 2018/177122 A1 (portable grinding device), CN 114903354 A, and US 2004/069881 A1 (traditional manual grinder) confirm the existing state of the art but do not solve the fundamental problems of ergonomics and user effort.

These devices indeed require the user to apply:
(a) a constant rotary force to start and keep the grinding elements in motion; and
(b) a continuous manual pressure force from top to bottom to keep the two parts constituting the grinding chamber in close contact during use, thereby preventing misalignment and ensuring grinding effectiveness.

This double effort makes the operation tiring and unergonomic, especially when dealing with harder or more fibrous herbs that offer greater resistance. Furthermore, none of the cited devices includes any system for accumulating and returning energy that reduces the overall effort required by the user.

### DISCLOSURE OF THE MODEL

In order to overcome the aforementioned disadvantages, the present device has been designed to provide a semi-automatic herb grinder that:
1. Reduces the effort required to keep the parts rotating;
2. Does not require the user to apply any continuous pressure force to the parts constituting the grinding chamber during use;
3. Optimizes the force applied by the user, storing elastic potential energy and returning it to perform useful work.

The device according to the model achieves these advantages thanks to a new and inventive technical combination of elements, which comprises:
a) An elastic mechanical member (4), configured for a dynamic function of energy accumulation and return. Unlike the simple return or pressure springs used in other devices of the known art (such as those for adjusting axial force or for the passive rewinding of a cord), the elastic mechanical member (4) of the present device is specifically configured and dimensioned to store a significant amount of elastic potential energy when loaded by the manual rotation imparted by the user (e.g., via the cable pull 10). Subsequently, it is configured to actively return this energy, causing the automatic rotation of the grinding elements (5a) in the opposite direction, thus actively performing part of the grinding work and reducing the effort required by the user. In a preferred form of implementation, said elastic mechanical member is a spiral spring (4).
b) Releasable mechanical coupling means (1c, 7c), configured to eliminate manual pressure. The device is equipped with releasable mechanical coupling elements (1c, 7c). These elements, preferably threaded elements, mechanically lock the first part (5) and the second part (7) of the grinding chamber together. This mechanical locking ensures correct adhesion and alignment throughout the entire grinding operation without any need for the user to apply a continuous manual downward pressure force, thus resolving the second fundamental disadvantage of known devices.
c) An internal architecture optimized for semi-automatic operation.
To enable the correct operation of the elastic mechanical member (4), the device features an innovative internal architecture comprising:

A shell (1) that acts as a supporting structure.

A container (2) housed in a rotatable manner in the shell (1) and intended to contain the elastic mechanical member (4).

A circular plate (5) fixed to the container (2) and equipped with the first mechanical grinding elements (5a). The plate rotates together with the container (2).

A locking system (la), such as a sectioned pin, fixed to the shell (1) to lock one end of the elastic member (4).

A ball bearing (3) interposed between the container (2) and the shell (1) to facilitate and smooth the relative rotation.

A flexible cable (10) connected to the elastic mechanical member (4) through a side opening (2a) in the container and a hole (1b) in the shell, which serves as a means for manually operating the mechanism.

### BRIEF DESCRIPTION OF THE DRAWINGS

FIG. 1 shows a two-dimensional front section of the model disassembled;

FIG. 2 shows a two-dimensional front section of the model assembled;

FIG. 3 shows a three-dimensional exploded view from above of the model;

FIG. 4 shows a three-dimensional exploded view from below of the model

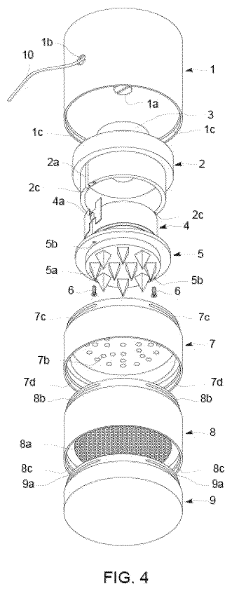

FIG. 5 shows a two-dimensional front view of the assembled model, with the second part itself acting as a primary collection chamber for the ground material.

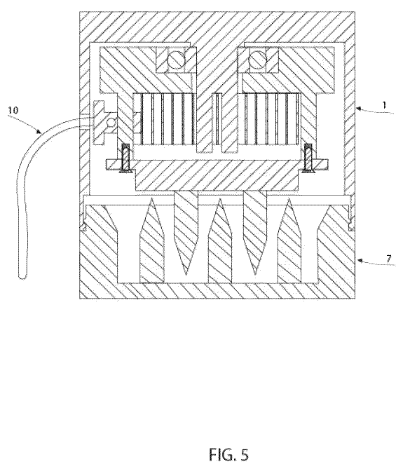

### DETAILED DESCRIPTION OF THE MODEL

The model will now be explained with reference to the accompanying drawings, which show an example of an embodiment of the semi-automatic device for grinding herbs and similar products according to the model.

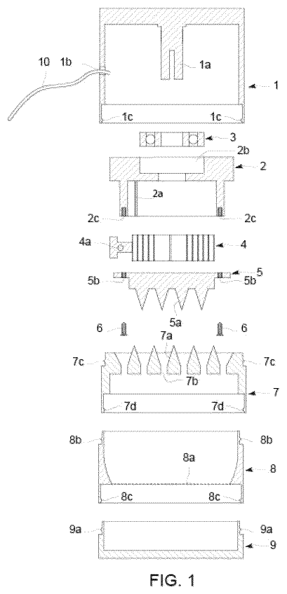

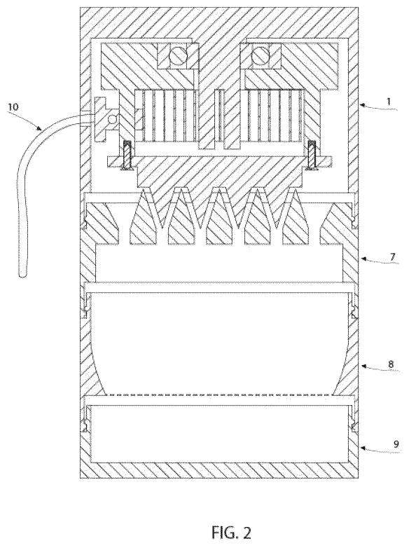

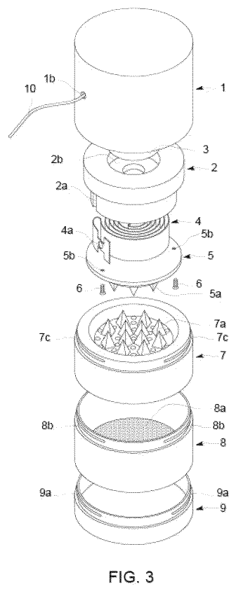

A semi-automatic device for grinding herbs and similar products according to FIGS. 1, 2, 3,4 and 5 comprises a shell (1) that acts as a container for elements no. (2, 3, 4, 5, and 6) which constitute the upper part of the mechanical grinding chamber and a part of element (10), i.e., the means that activates the elastic mechanical member.

This shell (1) is equipped with a locking system for the elastic mechanical member. In a preferable embodiment, this locking system consists of a sectioned central pin (la).

The shell (1) is also equipped with a hole (1b) and releasable coupling means (1c). In a preferred embodiment, these coupling means consist of screwable components.

The shell (1) houses the container for the elastic mechanical member (2). This container (2) contains the elastic mechanical member which, in a preferred embodiment, consists of a spiral spring (4) that is locked by element (la).

The container (2) is equipped with a side window (2a) from which one end of the spring (4a) protrudes and which is connected to the cable (10) used to operate the mechanism via the hole (1b). This container is also equipped with an element (2b) designed to accommodate solutions for facilitating its rotary movement actuated by the cable. In a preferred embodiment, this solution is represented here by a ball bearing (3).

The container of the elastic mechanical member (2) is also equipped with releasable coupling means (2c) whose function is to fix said container to the circular plate (5).

The circular plate (5), equipped with mechanical elements suitable for grinding herbs (5a), is fixed to the container (2) of the elastic mechanical member (4) by means of releasable coupling means (2c, 5b, and 6). In a preferred embodiment, the releasable coupling means consist of screwable elements.

The other part of the grinding chamber (7) also consists of mechanical elements suitable for grinding herbs (7a) and may be equipped with holes (7b) to allow the passage of the finely ground herbs into the lower container (8) and with releasable coupling means (7c), designed to ensure, even during use, the adhesion between the two parts that constitute the grinding chamber without the use of pressure force by the user. In the example shown, elements (1c) and (7c) hold the grinding chamber together. In a preferred embodiment, these releasable coupling means consist of screwable elements. Element (7) may also be equipped with releasable coupling means (7d) that ensure adhesion to element (8). In an alternative embodiment, the lower part (7) of the grinding chamber may be devoid of the aforementioned holes (7b) and the aforementioned releasable coupling means (7d), itself acting as the primary collection chamber for the ground herbs.

Element (8) represents the container in which the ground herbs are collected in the grinding chamber and filtered through the holes (7b) located in the lower part of the grinding chamber itself. The container is also equipped with a sieve (8a) with the function of filtering the secondary elements resulting from the grinding. The container (8) is equipped with releasable coupling means (8b) and (8c) which join those (7d) located in the lower part of (7) and those (9a) located on component (9).

Element (9) functions as a means to collect the secondary products resulting from the grinding which are filtered through the sieve (8a). Element (9) is also equipped with releasable coupling means (9a) designed to join those (8c) located in the lower part of element (8).

Element (10) consists of a cable which, once attached to the end of the retractable spring (4a) through the hole (1b) located on the shell (1), activates the mechanism that allows the grinding of the herbs.

### BEST MODE FOR CARRYING OUT THE MODEL

When the user pulls the traction element (10), the traction element (10) passes through the shell (1) via the hole (1b) and pulls the elastic element (4) by means of the other end (4a) of the elastic element (4) exposed through the side window (2a). The elastic element (4) rotates independently around the sectioned central pin (la) inside the shell (1) and rotates the elastic element container (2) through the side window (2a). The elastic element container (2) is removably connected to the upper circular plate (5) and rotates the upper grinding element (5a) to chop the herbaceous plants. At the same time, since the lower circular plate (7) is removably connected to the shell (1) and the upper grinding element (5a) and the lower grinding element (7a) are distributed in a staggered position above and below, it is possible to form a relative rotary movement to grind the herbaceous plants.

When the user releases the traction element (10), the elastic potential energy of the elastic mechanical member (4) returns the elastic mechanical member container (2) and the upper circular plate (5) connected to the elastic mechanical member container (2) to their initial position through the side window (2a), thus creating a rotary movement in the opposite direction, allowing further grinding even when the user is not applying force. This means that the force required to rotate the components of the grinding chamber is reduced, enabling more rotation to be generated compared to a conventional manual herb grinder to which the same force is applied.

During the above operation, the grinding chamber comprising the upper and lower parts is kept tightly fastened because the upper circular plate (5) is removably connected to the elastic element container (2) and the lower circular plate (7) is removably connected to the shell (1). This means that the user is still able to adequately grind herbs and the like without having to exert pressure on the parts comprising the grinding chamber.

The various technical features of the embodiments described above can be combined arbitrarily, and for the sake of brevity of description, not all possible combinations of the various technical features of the embodiments described above have been described. However, as long as there are no contradictions in the combination of these technical features, they should be considered to be within the scope of this specification.

The above is only a preferred embodiment of the model and it should be noted that, for a person skilled in the art, without departing from the creative idea of the model, a number of modifications and improvements can be made, all of which fall within the scope of protection of the utility model.

What is claimed is:

1. A semi-automatic device for grinding herbs or similar products, characterized by comprising:
a first part provided with first grinding elements;
a second part provided with second grinding elements, wherein the first and second parts are couplable to form a grinding chamber;
releasable coupling means configured to maintain said first and second parts in mechanical assembly during the grinding operation;
an elastic mechanical member configured to store elastic potential energy during rotation in a first direction and to return the stored energy by causing automatic rotation in a second direction opposite to the first;
traction means connected to the elastic mechanical member and configured to manually actuate it;
wherein the elastic mechanical member is mechanically connected to the first part such that rotations in said first and second directions cause relative rotation between the first and second grinding elements for grinding the material, thereby reducing the effort required by the user.

2. Device according to claim 1, characterized in that said elastic mechanical member is a spiral spring.

3. Device according to claim 1, characterized in that said releasable coupling means are complementary threaded elements.

4. Device according to claim 1, characterized by comprising:
a shell structured to house said first part;
a container housed rotatably in the shell and configured to contain said elastic mechanical member;
wherein said traction means comprise a flexible cable mechanically connected to the elastic mechanical member and configured to apply a torsional force, and wherein the first part is fixed to the container so as to rotate integrally with it.

5. Device according to claim 4, characterized by comprising a locking system fixed to the shell and configured to lock a first end of the elastic mechanical member.

6. Device according to claim 5, characterized in that said locking system is a sectioned central pin.

7. Device according to claim 4, characterized in that the shell is provided with a hole for the passage of the flexible cable.

8. Device according to claim 4, characterized in that the container is provided with a lateral opening through which a portion of the elastic mechanical member extends for connection to the traction means.

9. Device according to claim 4, characterized by comprising a ball bearing interposed between the container and the shell to facilitate relative rotation between them.

10. Device according to claim 9, characterized in that the container is provided with a housing configured to accommodate the ball bearing.

11. Device according to claim 4, characterized in that the first part is a circular plate fixed to the container by means of screwable fastening elements.

12. Device according to claim 1, characterized in that the second part comprises the second grinding elements and coupling elements complementary to the coupling elements of the shell.

13. Device according to claim 12, characterized in that the coupling elements of the second part are threaded elements complementary to the threaded coupling elements of the shell.

14. Device according to claim 1, characterized in that the second part is provided with holes for the passage of the ground material.

15. Device according to claim 1, characterized in that the second part is devoid of passage holes and releasable coupling means for engaging a secondary container, functioning itself as the primary collection chamber for the ground material.
